(19) United States
(12) Patent Application Publication
(10) Pub. No.: US 2011/0005792 A1
(43) Pub. Date: Jan. 13, 2011

(54) HANDHELD POWER TOOL WITH TWO-HANDED GRASP

(76) Inventors: Wolf MATTHIAS, Stuttgart (DE); Thomas Heinrich, Nellmersbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/834,207

(22) Filed: Jul. 12, 2010

(30) Foreign Application Priority Data
Jul. 13, 2009 (DE) 10 2009 027 640.8

(51) Int. Cl. B25F 5/00

(52) U.S. Cl. 173/170

(57) ABSTRACT

The invention is based on a handheld power tool having a drive unit, a grip unit that includes at least two grip areas for two-handed use, and a safety sensor unit, which has at least one sensor and one power limitation unit. It is proposed that the power limitation unit, in at least one operating state, as a function of a signal of the at least one sensor of the safety sensor unit, limits a supply of power to the drive unit at a level that is other than zero and unequal to a maximum available power.

### CROSS-REFERENCE TO RELATED APPLICATION

This application is based on German Patent Application 10 2009 027 640.8 filed Jul. 13, 2009.

### BACKGROUND OF THE INVENTION

1. Field of the Invention

The invention is based on a handheld power tool having a drive unit.

1. Description of the Prior Art

A handheld power tool, in particular electrical hedge shears, is known in which a supply of electrical power to the drive unit is dependent on two electric switches on two handles being in a predetermined switch position.

### ADVANTAGES AND SUMMARY OF THE INVENTION

The invention is based on a handheld power tool, having a drive unit and having a grip unit that includes at least two grip areas for two-handed use, and having a safety sensor unit, which has at least one sensor and one power limitation unit. The term “grip area” should be understood in this connection in particular to mean a part of the handheld power tool that is intended and equipped for being touched and held by the palm of a hand of a user upon manipulation during operation of the handheld power tool, and which in particular upon manipulation of the handheld power tool is grasped by one hand of the user. In particular, a grip area may also be embodied by a supplementary handle that is usual in handheld power tools. The term “safety sensor unit” should be understood in this connection in particular to mean a unit which has at least one sensor that is embodied separately from an actuation switch of the handheld power tool.

It is proposed that the power limitation unit, in at least one operating state, as a function of a signal of the at least one sensor of the safety sensor unit, limits a supply of power to the drive unit at a level that is other than zero and unequal to a maximum available power. As a result, advantageously, a power output of the handheld power tool can be made dependent on how the user guides the handheld power tool. Advantageously, the at least one sensor of the safety sensor unit is assigned to one of the at least two grip areas. The term “assigned” should be understood in this connection to mean in particular that the at least one sensor detects a physical measurement variable that is associated with the applicable grip area and one hand of the user. In particular, a cancellation of a power limitation, for instance in the upper third of a power range of the handheld power tool, can be made dependent on secure guidance of the handheld power tool by the user, which makes it possible to increase the safety of use of the handheld power tool. Canceling the power limitation, for instance in a lower third of the power range of the handheld power tool, can advantageously be done with one-handed guidance of the handheld power tool, if it is ensured that there is little potential risk to the user.

It is also proposed that the safety sensor unit includes at least two sensors, which are assigned to one of the at least two grip areas of the grip unit, and the power limitation unit is provided for limiting a supply of power to the drive unit, in at least one operating state, as a function of the signals of the at least two sensors of the safety sensor unit. As a result, impermissible bypassing of the actuation switch of the handheld power tool can advantageously be distinguished from secure guidance with both hands, and risky operation of the handheld power tool can be prevented. For instance, a first sensor of the at least two sensors can be formed by a force transducer, and a second sensor of the at least two sensors can be formed by a temperature sensor. It is advantageously possible to prevent operation of the handheld power tool, despite the fact that one condition of a signal of the first sensor, engendered by a holding force from the impermissible exertion of mechanical clamping, is met; this is because the lack of body heat from a user's hand leads to a persistent failure to meet a condition of a temperature-related signal of the second sensor. Especially advantageously, a supply of power to the drive unit at a level that is other than zero and is unequal to a maximum available power can be limited, as a function of the signals of the at least two sensors of the safety sensor unit, to enable operation of the handheld power tool that is adapted to the manner with which the user guides it; as a result, great operating safety for the user can be attained.

If the handheld power tool has an evaluation unit for evaluating the signals of the sensors of the sensor unit, fast signal processing and especially simple, fast monitoring of the power limitation of the drive unit can advantageously be furnished.

In an advantageous feature, the evaluation unit includes at least one electronic comparator circuit, which is intended for digitizing at least one signal of the sensors. The term “digitizing” should be understood in this connection to mean in particular a conversion of continuous variables into discrete values. As a result, conditions of signals of the sensors, in particular conditions of analog signals, can be especially simply evaluated in an electronic form. The electronic comparator circuit can be formed by one or more individual comparators and/or one or more window comparators. One skilled in the art is familiar with current methods for the purpose.

It is also proposed that the evaluation unit is provided for using at least one calculation rule and/or assignment table, stored in memory in its access region, for defining a power limitation as a function of the signals of the sensors of the safety sensor unit. As a result, the signals of the sensors can advantageously be evaluated both singly and in combination, resulting in great flexibility of adaptation to various operating situations.

It is furthermore proposed that the evaluation unit is provided for furnishing at least three different signals, as a function of an evaluation of the signals of the sensors of the safety sensor unit, in order to limit the supply of power to the drive unit, as a result of which simple control of the drive unit can be attained. Preferably, two of the at least three different furnished signals can be identified with power limitations to a value of zero and a value that is equivalent to a maximum available power of the handheld power tool. The third of the at least three different signals can preferably correspond to a power limitation to a value for power of the handheld power tool that is other than zero and is unequal to a maximum available power of the handheld power tool.

It is furthermore proposed that the power limitation unit has at least three power limitation stages, for limiting the supply of power to the drive unit. As a result, simple control of the power limitation of the handheld power tool can be furnished. The term “control” should be understood in this connection to mean a purposeful actuation in a purely open-loop control sequence and/or a closed-loop control sequence. Preferably, the number of signals furnished by the evaluation unit for limitation can be adapted to the number of power limitation stages of the power limitation unit.

If the evaluation unit and the power limitation unit are embodied at least partially in one piece, evaluation of the signals of the sensors of the safety sensor unit and a resultant power limitation of the handheld power tool can be achieved especially simply and economically.

It is moreover proposed that at least one of the sensors of the safety sensor unit is embodied as a force transducer, as a result of which a limitation of the supply of power to the drive unit of a magnitude that definitively determines secure guidance of the handheld power tool can be made possible. Advantageously, a further sensor of the safety sensor unit can detect a different physical variable, which furnishes additional information about the guidance of the handheld power tool, which can be used for defining a power limitation. Preferably, sensors for detecting a temperature or a surface dampness can also be used, as can a capacitive sensor, embodied as a contact sensor, which is preferably distributed over the surface of at least one of the at least two grip areas.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a side view of a handheld power tool of the invention, with a safety sensor unit;

FIG. 2 is a block circuit diagram of a safety sensor unit of FIG. 1;

FIG. 3 shows one example of digitizing one of the analog signals of the sensors; and

FIG. 4 is a graph showing an assignment table for defining a power limitation.

### DESCRIPTION OF THE PREFERRED EMBODIMENTS

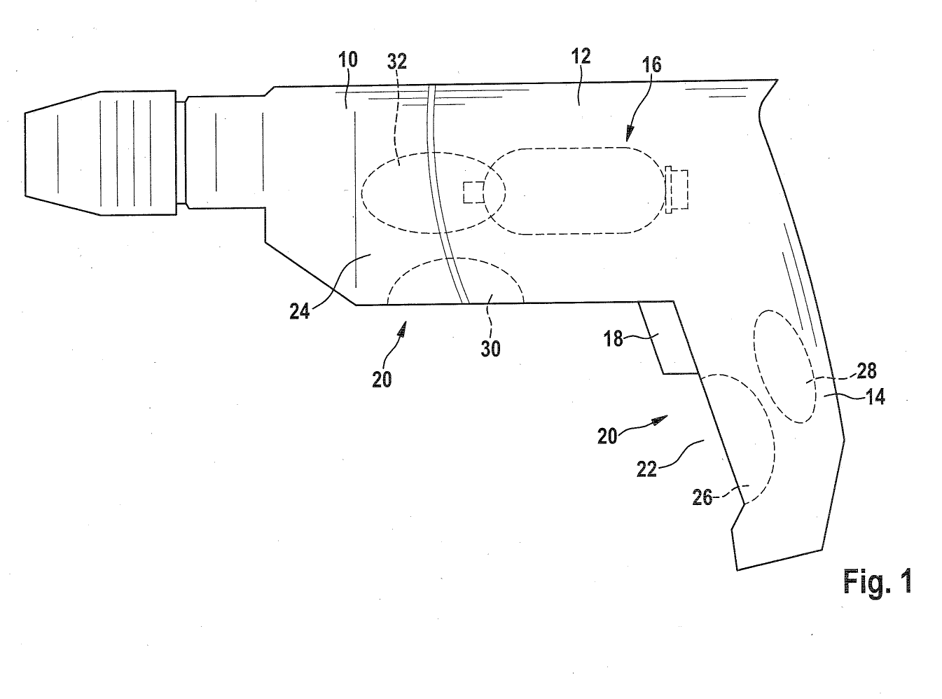

In FIG. 1, a side view is shown of a handheld power tool, embodied as a rotary hammer The handheld power tool, in the known manner, includes a gear housing 10 and a motor housing 12 with an integrated handle 14. The handheld power tool furthermore contains a drive unit 16, which has an electric motor, and an actuation switch 18 for activating the drive unit 16. The handheld power tool furthermore has a grip unit 20, which includes two grip areas 22, 24 for two-handed use. The first of the two grip areas 22, 24 is disposed on the integrated handle 14 and includes a sensor area 26 below the actuation switch 18 and one sensor area 28 each on both sides of the integrated handle 14, at the level of the actuation switch 18, so that a user who holds the handheld power tool with one hand at the integrated handle 14 for actuating the actuation switch 18 touches at least two sensor areas 26, 28 of the first grip area 22 with an initially unknown holding force F. The second grip area 24 is disposed at an interface of the gear housing 10 and the motor housing 12 and includes a sensor area 30 on an underside of the gear housing 10 and one sensor area 32 each on both sides of the interface between the gear housing 10 and the motor housing 12, so that a user who grasps the handheld power tool at the second grip area 24 for guiding the tool touches at least two sensor areas 30, 32 of the second grip area 24 with an initially unknown holding force F.

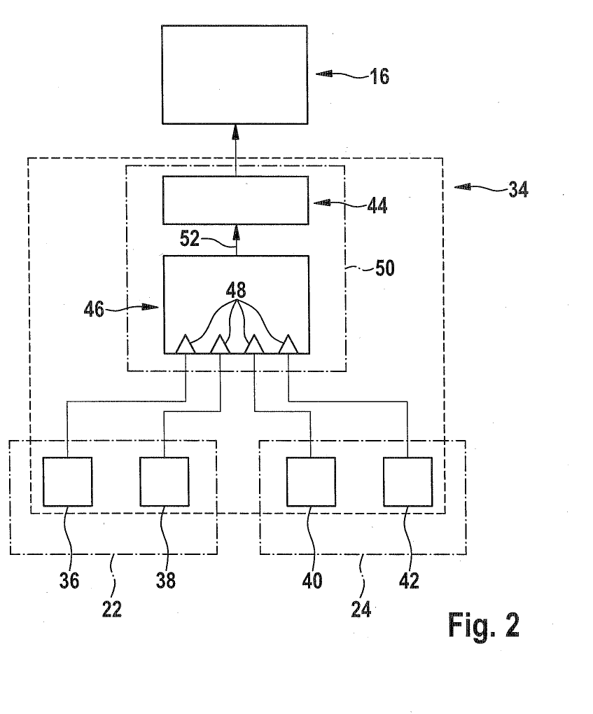

The handheld power tool further includes a safety sensor unit 34, which has a plurality of sensors 36, 38, 40, 42 and a power limitation unit 44. In FIG. 2, a block circuit diagram is shown which describes the cooperation of components of the safety sensor unit 34 for controlling the drive unit 16. The term “control” should be understood in this connection to mean a purposeful actuation in a purely open-loop control sequence and/or a closed-loop control sequence. A first sensor 36 of the safety sensor unit 34 is embodied as a force transducer and is assigned to the sensor area 26 below the actuation switch 18. A second sensor 38 of the safety sensor unit 34 detects a surface dampness and is assigned to the sensor areas 28 on both sides of the integrated handle 14 at the level of the actuation switch 18. A third sensor 40 of the safety sensor unit 34 detects the surface dampness and is assigned to the sensor area 30 on the underside of the gear housing 10. A fourth sensor 42 of the safety sensor unit 34 is embodied as a force transducer and is assigned to the sensor areas 32 on both sides at the interface between the gear housing 10 and the motor housing 12. Thus the safety sensor unit 34 contains four sensors 36, 38, 40, 42, of which two sensors 36, 38 and 40, 42 each are assigned to one of the two grip areas 22 and 24, respectively, of the grip unit 20. The power limitation unit 44, in at least one operating state, as a function of a signal S of the at least one sensor 36, 38, 40, 42 of the safety sensor unit 34, is intended for limiting a supply of power P to the drive unit 16 at a level that is other than zero and unequal to a maximum available power Pₘₐₓ.

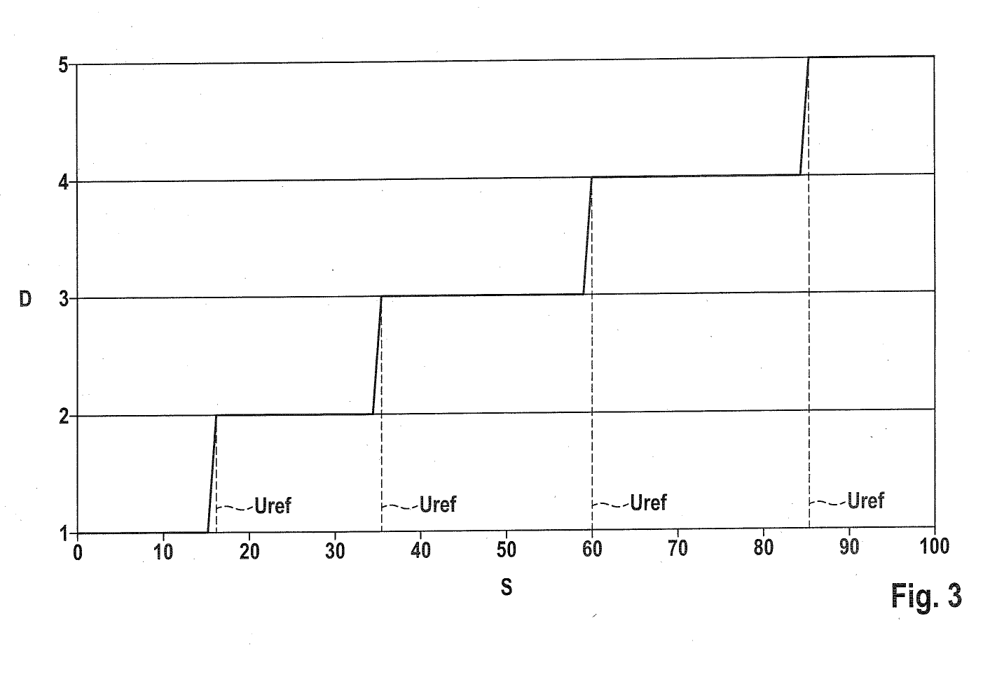

For evaluating the signals S of the four sensors 36, 38, 40, 42 of the safety sensor unit 34, the handheld power tool is equipped with an evaluation unit 46. The evaluation unit 46 has four electronic comparator circuits 48, which are provided for digitizing the analog signals S of the four sensors 36, 38, 40, 42 of the safety sensor unit 34. The comparator circuits 48 are embodied as window discriminators that are familiar to one skilled in the art and are not described in further detail here. As a function of reference voltages U_{ref} stored in memory in the evaluation unit 46, the window discriminators convert the analog signals S of the sensors into discrete values D (FIG. 3) for the sake of further evaluation.

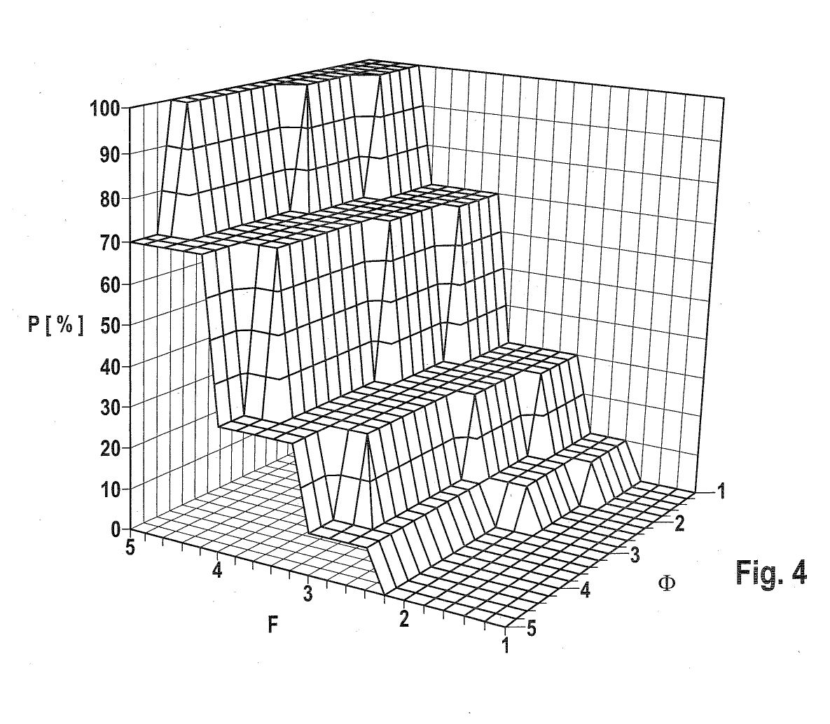

The evaluation unit 46 is provided for using an assignment table, stored in its access region, for defining a power limitation as a function of the signals S of the sensors of the safety sensor unit 34. FIG. 4 shows a graph of the assignment table for evaluating the sensors 36, 38, 40, 42 assigned to the various grip areas 22, 24. One value of a power limitation is assigned to each pair of values comprising discrete values D for a surface dampness Φ and a holding force F, which have been converted by the window discriminators from the analog signals S of the sensors 36, 38, 40, 42. Up to a minimum holding force F, for all values of the surface dampness Φ, a power P of the handheld power tool is limited to zero. From a minimum holding force F onward, the supply of power P to the drive unit 16 is limited at a level that is other than zero and unequal to a maximum available power Pₘₐₓ. As can be seen from FIG. 4, the value of the power limitation drops, for a constant holding force F and an increasing surface dampness Φ. This takes into account the fact that a static friction force at a damp point of contact between the user's hand and the grip areas 22, 24 is less than at a dry contact point and tends more to slipping. The evaluation unit 46 is provided for defining a power limitation to the maximum available power Pₘₐₓ if the surface dampness Φ drops below a value stored in memory, and a holding force F is above a further value stored in memory.

The evaluation unit 46 is intended for performing an evaluation in the same direction for the two sensors each of the sensors 36, 38 and 40, 42 assigned to each of the two grip areas 22 and 24, respectively. For the sensors 36, 38 that are assigned to the grip area 22 on the integrated handle 14, the assignment table of FIG. 4 applies. For the two sensors 40, 42 that are assigned to the grip area 24 on the underside of the gear housing 10 and with the interface between the gear housing 10 and the motor housing 12, an assignment table not described further here applies, which is similar to that of FIG. 4 but uses other reference voltages U_{ref}, stored in memory in the evaluation unit 46, for the digitization, in order to take different properties of the grip areas 22, 24 into account. The evaluation unit 46 is intended for defining two values of the power limitation from the signals S of the two sensors each of the sensors 36, 38 and 40, 42 assigned to the respective grip areas 22 and 24, and for forming a geometric mean from these two values as a mean value, in order to define a power limitation of the drive unit 16. The term “geometric mean” of two numbers should be understood in this connection to mean in particular a mean value whose square is equal to the product of the two numbers. As a consequence, one-handed operation of the handheld power tool, in which the user, with one hand, guides the handheld power tool on the integrated handle 14 and actuates the actuation switch 18, is not possible, and this is appropriate for safety reasons for a handheld power tool embodied as a rotary hammer. In principle, in handheld power tools with little potential risk, other combinations of the two defined values for the power limitation that make one-handed operation of the handheld power tool possible are conceivable. For instance, in a handheld power tool formed by a cordless rotary driver, the two defined values of the power limitation are added together, including with different weighting of the two grip areas 22, 24, so that in one-handed operation, a portion, defined in advance and other than zero, of the maximum available power Pₘₐₓ can be supplied.

The evaluation unit 46 is furthermore provided, as a function of an evaluation of the signals S of the sensors 36, 38, 40, 42 of the safety sensor unit 34 and based on the power limitation defined with the assignment table, for furnishing five different signals 52, in order to limit the supply of power P to the drive unit 16; each of the five different signals 52 corresponds to one power stage shown in FIG. 4. The signal 52 of the evaluation unit 46 serves to trigger the power limitation unit 44 (FIG. 2) embodied in one piece on the same circuit board, which has five power limitation stages, for limiting the supply of power P to the drive units 16. There is an unambiguous assignment of each of the five different signals 52 of the evaluation unit 46 to one of the five power limitation stages of the power limitation unit 44.

The foregoing relates to preferred exemplary embodiments of the invention, it being understood that other variants and embodiments thereof are possible within the spirit and scope of the invention, the latter being defined by the appended claims.

1. A handheld power tool, having a drive unit and having a grip unit that includes at least two grip areas for two-handed use, and having a safety sensor unit, which has at least one sensor and one power limitation unit, wherein the power limitation unit, in at least one operating state, as a function of a signal of the at least one sensor of the safety sensor unit, limits a supply of power to the drive unit at a level that is other than zero and unequal to a maximum available power.

2. The handheld power tool according to claim 1, wherein the safety sensor unit includes at least two sensors, which are assigned to one of the at least two grip areas of the grip unit, and the power limitation unit is provided for limiting a. supply of power to the drive unit, in at least one operating state, as a function of signals of the at least two sensors of the safety sensor unit.

3. The handheld power tool according to claim 1, further having an evaluation unit for evaluating signals of the at least one sensor of the safety sensor unit.

4. The handheld power tool according to claim 2, further having an evaluation unit for evaluating the signals of the at least two sensor of the safety sensor unit.

5. The handheld power tool according to claim 3, wherein the evaluation unit has at least one electronic comparator circuit, which is provided for digitizing at least one signal of the sensors of the safety sensor unit.

6. The handheld power tool according to claim 4, wherein the evaluation unit has at least one electronic comparator circuit, which is provided for digitizing at least one signal of the sensors of the safety sensor unit.

7. The handheld power tool according to claim 3, wherein the evaluation unit is provided for using at least one calculation rule and/or assignment table, stored in memory in its access region, for defining a power limitation as a function of the signals of the sensors of the safety sensor unit.

8. The handheld power tool according to claim 4, wherein the evaluation unit is provided for using at least one calculation rule and/or assignment table, stored in memory in its access region, for defining a power limitation as a function of the signals of the sensors of the safety sensor unit.

9. The handheld power tool according to claim 3, wherein the evaluation unit is provided for furnishing at least three different signals, as a function of an evaluation of the signals of the sensors of the safety sensor unit, in order to limit the supply of power to the drive unit.

10. The handheld power tool according to claim 4, wherein the evaluation unit is provided for furnishing at least three different signals, as a function of an evaluation of the signals of the sensors of the safety sensor unit, in order to limit the supply of power to the drive unit.

11. The handheld power tool according to claim 1, wherein the power limitation unit has at least three power limitation stages, in order to limit the supply of power to the drive unit.

12. The handheld power tool according to claim 3, wherein the evaluation unit and the power limitation unit are embodied at least partially in one piece.

13. The handheld power tool according to claim 4, wherein the evaluation unit and the power limitation unit are embodied at least partially in one piece.

14. The handheld power tool according to claim 5, wherein the evaluation unit and the power limitation unit are embodied at least partially in one piece.

15. The handheld power tool according to claim 6, wherein the evaluation unit and the power limitation unit are embodied at least partially in one piece.

16. The handheld power tool according to claim 7, wherein the evaluation unit and the power limitation unit are embodied at least partially in one piece.

17. The handheld power tool according to claim 8, wherein the evaluation unit and the power limitation unit are embodied at least partially in one piece.

18. The handheld power tool according to claim 9, wherein the evaluation unit and the power limitation unit are embodied at least partially in one piece.

19. The handheld power tool according to claim 10, wherein the evaluation unit and the power limitation unit are embodied at least partially in one piece.

20. The handheld power tool according to claim 1, wherein at least one of the sensors of the safety sensor unit is embodied as a force transducer.
